(19) United States
(12) Patent Application Publication
(10) Pub. No.: US 2005/0287868 A1
(43) Pub. Date: Dec. 29, 2005

(54) Connecting member for covering members and connecting structure using the connecting member

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/158,232

(22) Filed: Jun. 20, 2005

Related U.S. Application Data
(63) Continuation of application No. PCT/JP05/05605, filed on Mar. 18, 2005.

(30) Foreign Application Priority Data
Apr. 20, 2004 (JP) P2004-124106

(51) Int. Cl. H01R 9/03

(52) U.S. Cl. 439/610

(57) ABSTRACT

The invention relates to a connecting member for covering members for forming a casing of an electronic device. The connecting member is a connecting member by which an end portion of a plurality of covering members is connected, including a covering member of which at least the end portion to be connected is made of a wooden material; and having at least one of an end holding portion and a side guide portion for connecting the covering members, the end holding portion being provided so that the end holding portion holds the top end of the end portion of each of the covering members, and, the side guide portion being provided along a side surface in a thickness direction of the end portion of each of the covering members.

### PRIORITY CLAIM

The present application is a continuation of International Application No. PCT/JP2005/005605, filed Mar. 18, 2005, whose priority is claimed on Japanese Patent Application No. 2004-124106, filed Apr. 20, 2004. The contents of both International Application and the Japanese Patent Application are incorporated herein by reference.

### BACKGROUND OF THE INVENTION

### Field of the Invention

The invention relates to a connecting member for covering members and to a connecting structure using the connecting member, and particularly relates to a connecting member for covering members and a connecting structure using the connecting member suitable for forming, for example, a casing of an electronic device.

A covering member for an electronic device such as a camera, a portable telephone, and an IC recorder, or an electronic device such as a remote control for consumer electronic products such as a television set, a video recorder, an air conditioner, and a projector constitutes a casing that contains built-in electronic parts or optical parts, and contributes to the design for outer appearance of these devices.

Conventionally, these covering members are made up of a relatively thin plate member, a shell member, or the like, as for the shape in order to reduce the size and the weight of the devices, and are generally produced of the materials such as synthetic resin or light metal, which are suitable for mass production.

On the other hand, materials such as synthetic resin or light metal have a disadvantage in that they are difficult to hold comfortably in the hand. Accordingly, a proposal has been made that as a covering material, natural materials such as wood or bamboo be used which tend to be comfortable in the hand and are endowed with delicate features which provide good sensation.

When this type of covering material is connected together to form a casing, it is common for the covering material to be connected so that an unnecessary gap is not exposed at a connecting portion. For example, covering materials made of synthetic resin or metal, which provides a slope that tapers in the direction of a tip or provides a bended portion in tiers, are joined by overlapping the tip of each covering member in the thickness direction.

Japanese Unexamined Patent Publication No. 2004-64021 (pages 2-4, and FIG. 1) discloses a component material for constructing a casing for electronic devices which is formed of a wooden material, and whose surface is carbonized. The Publication also discloses a camera covered by a front cover and a rear cover using a wooden material, both being a thin shell type, where a circuit unit and a imaging unit are attached to a chassis. The front cover and the rear cover include, at their ends, an inclination that tapers in the direction of a tip. One inclined portion creeps into the other to be connected through overlapping in the thickness direction.

### SUMMARY OF THE INVENTION

One aspect of the invention relates to a connecting member for covering members for forming a casing of an electronic device. The connecting member comprises a connecting member by which an end portion of a plurality of covering members is connected, including a covering member of which at least the end portion to be connected is made of a wooden material; and having at least one of an end holding portion and a side guide portion for connecting the covering members, the end holding portion being provided so that the end holding portion holds the top end of the end portion of each of the covering members, and, the side guide portion being provided along a side surface in a thickness direction of the end portion of each of the covering members.

Preferably, at least one of the end holding portion and the side guide portion is circularly continuous.

Advantageously, the side guide portion is provided with a fastening means for removably fastening the covering members.

Advantageously, either the end holding portion or the side guide portion projects outside of the side surface of the end portion of the covering members.

Preferably, the side guide portion is provided so as to hold the end portion of the covering member in the thickness direction thereof.

Another aspect of the invention relates to a connecting structure for forming a casing of an electronic device. The connecting structure comprises the connecting member as recited in one of above inventions; and a plurality of covering members each having an end portion to be connected, including the covering member of which at least the end portion to be connected being made of a wooden material.

Preferably, the connecting member for the covering members is formed of a material having higher strength than a wooden material of the end portion to be connected in the covering members.

### BRIEF DESCRIPTION OF THE DRAWINGS

FIG. 1 is a perspective view of a digital camera of which the covering members are connected by using a connecting member of an embodiment in accordance with the invention.

FIG. 2 is an exploded perspective view of a digital camera shown in FIG. 1 in order to illustrate a structure of a covering system thereof.

FIG. 3 is a sectional view taken along A-A of FIG. 1.

FIG. 4A is a sectional view taken along B-B of FIG. 1.

FIG. 4B is a sectional view taken along C-C of FIG. 1.

FIG. 4C is a sectional view taken along D-D of FIG. 2.

FIG. 5A is a sectional view of a fixing means that can be used in an embodiment in accordance with the invention.

FIG. 5B is a sectional view of a fixing means that can be used in an embodiment in accordance with the invention.

FIG. 5C is a sectional view of a fixing means that can be used in an embodiment in accordance with the invention.

FIG. 5D is a sectional view of a fixing means that can be used in an embodiment in accordance with the invention.

FIG. 6A is a sectional view of a first variant of an embodiment in accordance with the invention.

FIG. 6B is a sectional view of a second variant of an embodiment in accordance with the invention.

FIG. 6C is a sectional view of a third variant of an embodiment in accordance with the invention.

FIG. 6D is a sectional view of a third variant of an embodiment in accordance with the invention.

FIG. 6E is a sectional view of a fourth variant of an embodiment in accordance with the invention.

FIG. 6F is a sectional view of a fifth variant of an embodiment in accordance with the invention.

FIG. 7A is a side view of a sixth variant of an embodiment in accordance with the invention.

FIG. 7B is a sectional view taken along E-E of FIG. 7A.

### DETAILED DESCRIPTION OF THE INVENTION

Embodiments in accordance with the invention will be described with reference to the figures. In all the figures, even if the embodiments are different, the same reference numerals are applied to similar or equivalent elements, and explanations which are the same in the embodiments are omitted.

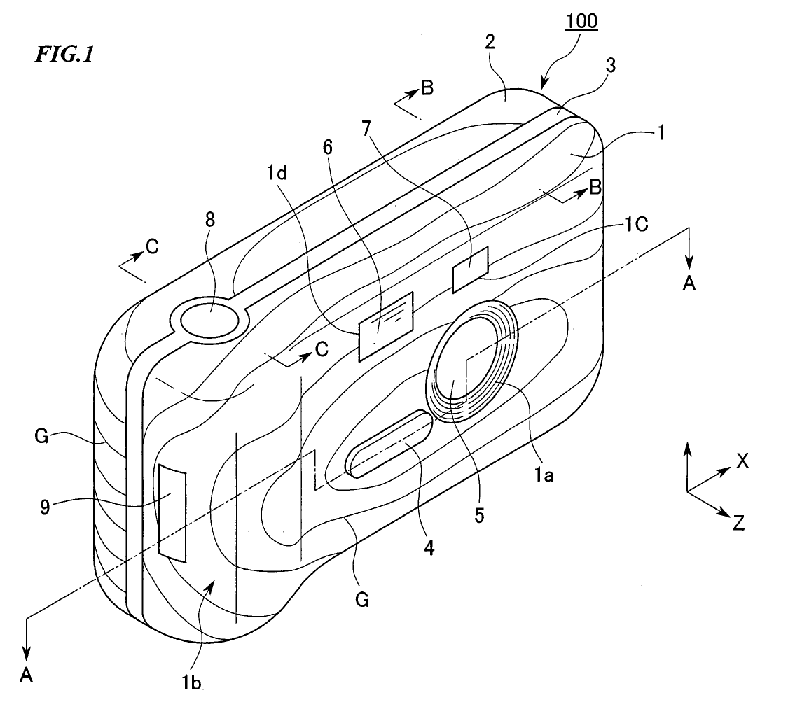

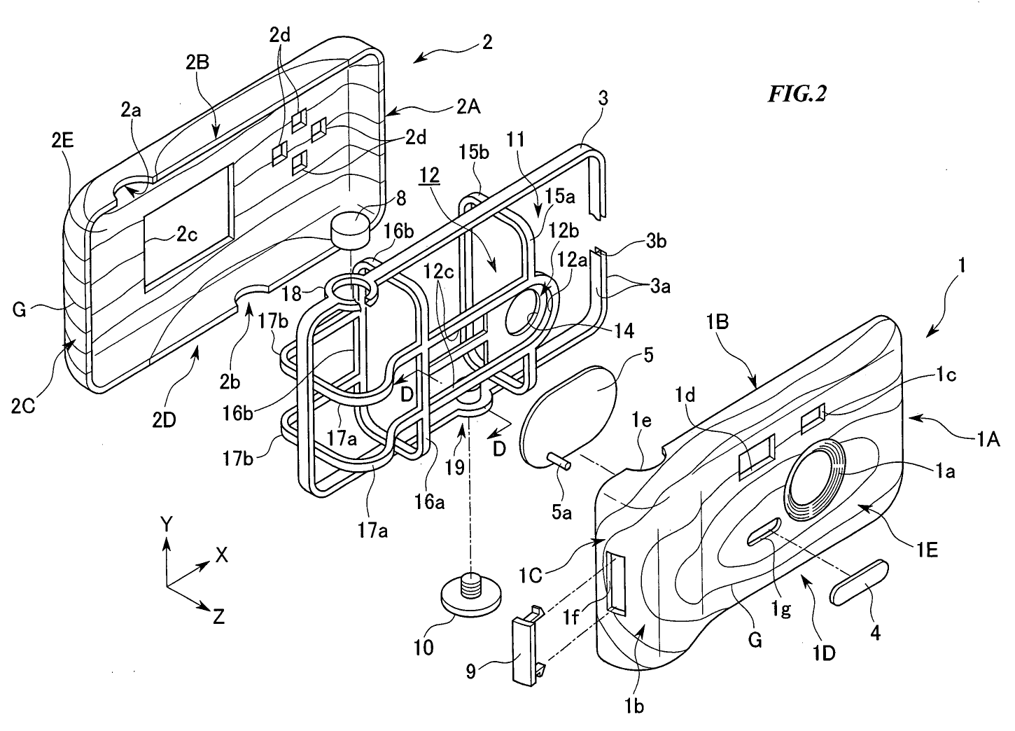

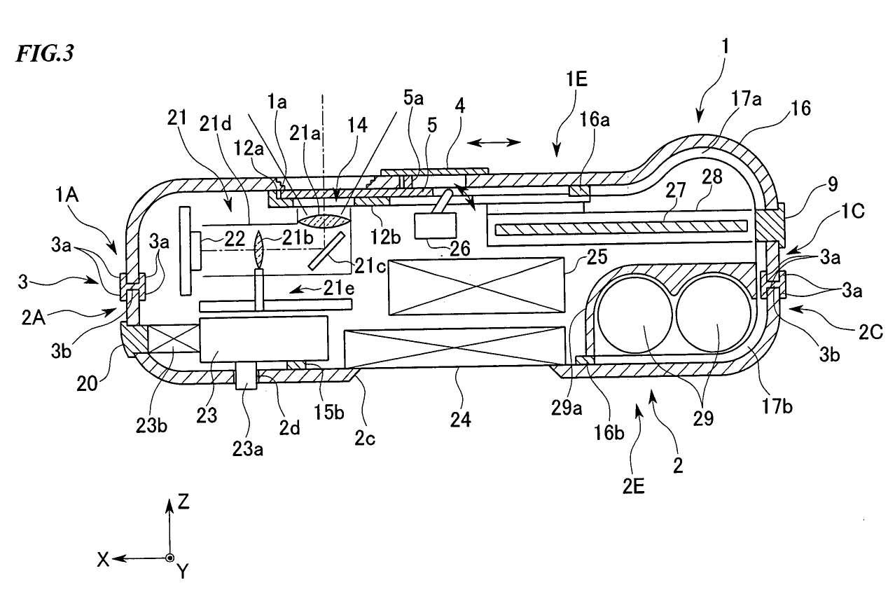

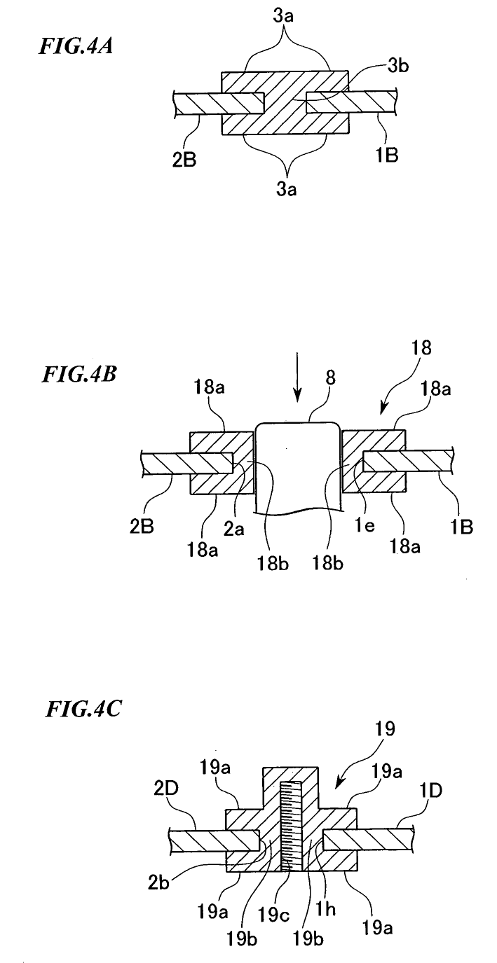

FIG. 1 is a perspective view of a digital camera of which the covering members are connected by using a connecting member of an embodiment in accordance with the invention. FIG. 2 is an exploded perspective view of a digital camera shown in FIG. 1 in order to illustrate a structure of a covering system thereof. FIG. 3 is a sectional view taken along A-A of FIG. 1. FIG. 4A is a sectional view taken along B-B of FIG. 1. FIG. 4B is a sectional view taken along C-C of FIG. 1. FIG. 4C is a sectional view taken along D-D of FIG. 2.

An X, Y, and Z rectangular coordinate system is described that is common to FIGS. 1 to 3. Under the coordinate system, when taking a position to take a photograph of an object in front holding a right side of a digital camera, a direction to the front is designated as a Z direction, a direction to the left as an X direction, and an upper vertical direction as a Y direction. For simplicity, relative directions may be explained hereunder referring to the coordinate system.

A connecting member for covering members of an embodiment in accordance with the invention connects ends of a plurality of covering members to form a casing. The connecting member can be used, for example, in a digital camera 100 (an electronic device) shown in FIG. 1.

A casing of the digital camera 100, as shown in FIGS. 1 and 2, is made up of a front cover 1 (a covering member), a rear cover 2 (a covering member), and a frame 3 (a connecting member for covering members).

The casing contains, as the covered parts, the well-known optical parts, mechanical parts, and electrical parts that are necessary for a digital camera. In this embodiment, as shown in FIGS. 1 and 3, are provided a built-in flash 6, a finder 7, an imaging unit 21, a liquid crystal display 24, an electrical control unit 23, a circuit unit 25, a memory card 27, batteries 29, and a barrier switch 26. One portion of the covered parts is exposed outside of an aperture provided on each of the front cover 1 and the rear cover 2.

The imaging unit 21, as shown in FIG. 3, is composed of a group of lenses 21a, a mirror 21c, and a group of lenses 21b which constitute a zoom lens optical system held at a lens barrel 21d, and a CCD as an image pick-up device, arranged at an image surface thereof.

The group of lenses 21a is a fixed group located nearest to an object.

The group of lenses 21b, at least a portion of which is set on an optical path folded by the mirror 21c, is a moving group movably held by a zooming mechanism 21e.

This structure enables the imaging unit 21 to perform a zooming without protruding from the casing.

A lens barrier 5 is used to cover the front of the group of lenses 21a when no photograph is taken. The lens barrier 5 is a plate in a shape of an ellipse or oval having a size that allows an imaging aperture 1a to be closed, and is made up of, for example, synthetic resin or metal.

When the lens barrier 5 is assembled, the minor axis of an ellipse or oval is guided to a lens barrier guide 12c (described later). On the lens barrier 5, a pin 5a is erected in a positive Z direction. The pin 5a, when assembled, is inserted into a slide hole 1g to be connected to a slide lever 4.

Thus, the movement of the lens barrier 5 can be realized by the movement of the slide lever 4 outside of the casing.

The barrier switch 26 is used to switch on or off the power of the digital camera 100 based on the movement of the lens barrier 5. As shown in FIG. 3, a switch lever 26a protrudes movably into a movement path of the lens barrier 5. When the lens barrier 5 covers the imaging aperture 1a, an electronic circuit is open. On the other hand, when the lens barrier 5 uncovers the imaging aperture 1a, the electronic circuit is closed.

The rear cover 2, as shown in FIG. 2, is of a box shape having an almost uniform thickness open to the positive Z direction that has a rectangular bottom plate 2E parallel to the XY plane, the circumference of which is enclosed by four sides.

At the top of each of the four sides are formed a left side end 2A and a right side end 2C in the positive and negative directions of the X axis, respectively, and an upper side end 2B and a lower side end 2D in the positive and negative directions of the Y axis, respectively. The end surface for each of these side ends is nearly aligned on a plane parallel to the XY plane.

In the upper side end 2B near the right side end 2C is provided a notch 2a that is cut out in the shape of a semicircle from the end surface of the upper side end 2B. In the middle of the lower side end 2D, a notch 2b is provided that is cut out in the shape of a semicircle from the end surface of the lower side end 2D.

In the nearly middle of the bottom plate 2E, the display aperture 2c is provided so that the liquid crystal display unit 24 can be seen from outside of the casing. In the left neighborhood (in the positive X axis direction) of the display aperture 2c, operation apertures 2d are provided to protrude the operation button 23a to the outside.

The rear cover 2 can employ wooden material, light metal (aluminum, stainless steel, titanium, magnesium, or the like) that allows press molding, or synthetic resin (ABS, polycarbonate, acrylic, or the like) that allows injection molding. In the embodiments wooden material is used that is excellent in hygroscopicity and superior in design making the most of natural features.

The wooden material used in the embodiments is compressed wooden material of which the density is enhanced and the strength is improved by compression molding.

Compression molding is performed as follows. Natural wood is cut relatively thick with regard to the thickness of the rear cover 2 to manufacture a prototype. The prototype is compression molded by dies in an atmosphere of high temperature water vapor to transfer the shape of the die surface. In this way, a thin shell type of member can be obtained, the surface of exposes woodgrain lines G, and the inside of which is much stronger than the prototype wooden material.

The notches 2a and 2b, the display aperture 2c, and the operation aperture 2d can be formed by, for example, secondary processing after compression molding.

In the embodiments, since the prototype for the rear cover 2 is cut out of an edge grain material, the cross section of a wood fiber is exposed at the end surfaces of the left side end 2A and the right side end 2C. Because cohesive force between the wood fibers is weak, the left side end 2A and the right side end 2C are easily broken or come off.

The surface of the rear cover 2 may be provided with a carbonizing layer or coating layer, or with a pattern, an unevennness, or the like, by secondary processing. Foreign materials such as synthetic resin and synthetic rubber, and metal can be embedded into or attached to the rear cover 2.

As a wooden material, the following can be selected: Japanese cypress, paulownia, teak, mahogany, Japanese cedar, pine, cherry tree, bamboo, or equivalents thereof. Not only raw wood but also a woody material such as a compression formed material that is made up of collected and solidified waste chips and sawdust can be used.

The front cover 1 is a formed article made of the similar compressed wooden material as the rear cover 2. The front cover 1, as shown in FIG. 2, is of a box shape having an almost uniform thickness open to the negative Z direction that has a rectangular bottom plate 1E parallel to the XY plane, the circumference of which is enclosed by four sides. Furthermore, in order to improve design, the front cover 1 uses a prototype cut out of a flat grain material so that complicatedly curved woodgrain lines G can be obtained. In this situation, as is the same with the rear cover 2, variation in strength of the ends occurs, depending on the way in which the woodgrain is overlapped at the ends.

At the top of each of the four sides are formed a left side end 1A and a right side end 1C in the positive and negative directions of the X axis, respectively, and an upper side end 1B and a lower side end 1D in the positive and negative directions of the Y axis, respectively. The end surface for each of these side ends is nearly aligned on a plane parallel to the XY plane.

In the upper side end 1B near the right side end 1C is provided a notch 1e that is cut out in the shape of a semicircle from the end surface of the upper side end 1B. In the middle of the lower side end 1D, a notch 1h is provided that is cut out in the shape of a semicircle from the end surface of the lower side end 1D (see FIG. 4C).

The notch 1e forms a round hole together with the notch 2a of the rear cover 2, and the notch 1h forms a round hole together with the notch 2b of the rear cover 2 when assembled.

Near the end surface of the right side end 1C, a insertion hole 1f for inserting and removing the memory card 27 is provided along the end surface thereof. A hole cover 9 can be removably mounted to the insertion hole 1f.

Near the right side end 1C of the bottom plate 1E, a grip 1b is formed that is swollen in a semicircle in the positive Z axis direction.

At the bottom plate 1E, the imaging aperture 1a to receive incident light is provided for a lens aperture of the imaging unit 21. The imaging aperture 1a, as shown in FIG. 3, has a slope to reduce its radius stepwise in the plate thickness direction of which the surface is carbonized to prevent stray light.

For the finder 7 and the built-in flash 6, a finder aperture 1c and a flash aperture 1d are provided to insert their top end, respectively.

Between the imaging aperture 1a and the grip 1b, a slide hole 1g is provided extending in the X axis direction. Into the slide hole 1g, a pin 5a of the lens barrier 5 placed inside of the front cover 1 can be inserted.

The frame is roughly so formed, as shown in FIG. 4A, that a rod material whose cross section is of an H shape, where a web 3b (an end holding portion ) is provided with side guides 3a (a side guide portion) as a flange, is bent according to a nearly rectangular aperture that each end of the front cover 1 and the rear cover 2 makes up to form a circular frame body (see FIG. 2). In order to show the cross section, FIG. 2 is partially broken.

The web 3b and the side guides 3a and 3a constitute a U-shaped groove that holds the ends of the front cover 1 and the rear cover 2, respectively. When the front cover 1 and the rear cover 2 are pushed in between the side guides 3a and 3a from the Z axis direction to be assembled, at least one portion of each of the end surfaces of the web 3b can strike against the front cover 1 and the rear cover 2, so that the location of the front cover 1 and the rear cover 2 in the direction which they are pushed in can be controlled.

The web 3b may be provided with a seal member for water proofing, moisture proofing, or dust proofing. In the case, the ends of the front cover 1 and the rear cover 2 may hit against the web 3b through the seal member.

On the frame 3, a release button attaching portion 18 and a screw portion 19 are formed which are difficult to form directly when the front cover 1 and the rear cover 2 are made of a wooden material.

The release button attaching portion 18 is provided to guide a release button 8 to be pressed in the Y axis direction in FIG. 2. For the purposes, a side guide 18a extended from the side guide 3a is provided at the outer circumference for the upper and lower ends of a guide cylinder 18b with which the release button engages.

For the purposes, as shown in FIG. 4 B, the guide cylinder 18b and the side guides 18a and 18a form a groove U-shaped in a cross section and curved semi-circularly in the ZX plane direction. When the front cover 1 and the rear cover 2 are pushed in the Z axis direction with respect to the frame 3 to be assembled, the notches 1e and 2a can be inserted along the respective grooves in terms of shape.

A screw portion 19 is provided so as to screw in a stand attachment screw 10 (see FIG. 2) set in a tripod, or the like, for supporting the digital camera 100. The screw portion 19 includes a boss having a downward aperture in the center of the lower side (in the negative Y axis direction) of the frame 3, and a side guide 19a extended from the side guide 3a at the outer circumference. Inside of the aperture of the boss 19b, a female screw 19c is formed that screws on the stand attachment screw 10 together.

The outer circumference of the boss 19b and the side guides 19a and 19a form a groove U-shaped in a cross section and curved semi-circularly in the ZX plane direction. When the front cover 1 and the rear cover 2 are pushed in the Z axis direction with respect to the frame 3 to be assembled, the notches 1h and 2b can be inserted along the respective grooves in terms of shape.

As a material for the frame 3, stronger synthetic resin or metal than the front cover 1 and the rear cover 2 can be employed.

To the inner circumference of the frame 3, a supporting frame 11 (a supporting member) is fixed. When the casing is assembled, the supporting frame 11 touches the inner surface of the front cover 1 and the rear cover 2, or is placed in a position adjacent to them. When an external force is applied to the front cover 1 and the rear cover 2, the supporting frame 11 is a reinforcing member for curbing their distortion to the inner side and preventing damage. When placed adjacent, an appropriate space is provided considering the amount of allowable deformation according to the strength of the front cover 1 and the rear cover 2.

A way of fixing the supporting frame 11 may be a suitable way such as welding, caulking, or thread fastening.

The supporting frame 11 contains front frames 15a, 16a, and 17a, rear frames 15b, 16b, and 17b, and a lens barrier storing portion 12, and is mainly composed of a frame structure of rod members having a cross section of a square.

The front frames 15a and 16a and the rear frames 15b and 16b are spaced with an interval in the middle of the longer direction of the frame 3, and are made up of a U-shaped member along a curvature of the inner surfaces of the front cover 1 and the rear cover 2 built between the span of the shorter direction of the frame 3. The front frame 15a is placed in a position corresponding to the left side (the positive X axis direction) of the imaging aperture 1a, while the front frame 16a is arranged in a middle position between the grip 1b and the imaging aperture 1a.

The front frame 17a and the rear frame 17b are placed with an interval in the middle of the shorter direction of the frame 3 to be built between the front frame 16a, the rear frame 16b, and frame 3, respectively. The front frame 17a and the rear frame 17b consist of an L-shaped member curved to be along the inner surface of the bottoms 1E and 2E. The front frame 17a contains a curvature for the grip 1b, in which an L-shaped bent portion projects circularly.

A lens barrier storing portion 12 accommodates the lens barrier 5 together with the front cover 1 to movably hold the lens barrier 5 to the X axis direction. The lens barrier storing portion 12 includes a lens barrier guide surface 12b provided at a position slightly lower than the front surface of the front frame 15a and 16a (the surface opposite to the bottom plate 1E) by a thickness of the lens barrier 5, a lens barrier stopper 12a having a curvature to stop the end of the major axis of the lens barrier 5 from the middle of the front frame 15a, and lens barrier guides 12c and 12c having a slightly wider interval than a minor axis width of the lens barrier in the Y axis direction between the front frame 15a and the front frame 16a. The front surface of the lens barrier guide 12c is aligned with the front frames 15a and 16a.

The lens barrier guide surface 12b has an aperture 14 in a position corresponding to the lens aperture of the imaging unit 21.

The supporting frame 11, integrally fixed with the frame 3, is a stress transferring member by which an external force applied through the front cover 1 and the rear cover 2 is dispersed to be transferred to the frame 3.

Being built in the frame 3, the supporting frame 11 is also a structural member for loading an external force from the circumferential direction of the frame 3. Moreover, as with the front frame 15a and the rear frame 15b, and the front frame 16a and the rear frame 16b, the structure circularly continuous to each other can resist an external force to reduce a load to the frame 3, which constitutes an advantage.

A various kinds of objects built in the casing can be touched with or fixed at the frame 3 and the supporting frame 11. For example, as shown in FIG. 3, the electrical control unit 23 is attached to the rear frame 15b. A battery case 29a is mounted to the rear frame 16b and the frame 3. A card holder 28 is mounted to the front frame 16a and the front frame 17a. Likewise, the members whose attachment partners are not shown in FIG. 3 are fixed at holding members (not shown) that are attached to the frame 3 and the supporting frame 11.

The connection structure among the front cover 1, the rear cover 2, and the frame 3 and the function thereof will be explained hereinbelow.

Since the digital camera 100 should be repaired by opening the casing when in trouble, the front cover 1 and the rear cover 2 are removably fixed to the frame 3. Although not shown in FIG. 2, for the drawings to be viewed easily, a fixing unit is provided at appropriate positions in the frame 3.

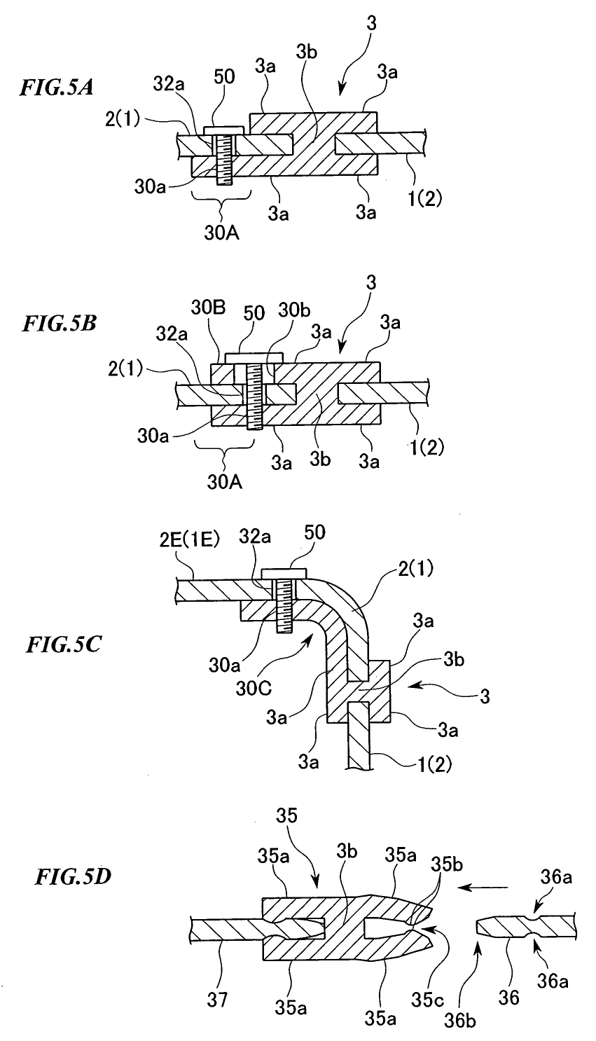

FIGS. 5A, 5B, and 5C are a cross section, respectively, that explains a fixing unit for the embodiments in accordance with the invention.

In the explanation shown below, as a matter of convenience, with respect to a position shown in the cross section of the figures, it is assumed that a fixing unit is provided at the rear cover 2, although it is freely chosen whether a fixing unit is provided at the front cover 1 or the rear cover 2 or both. If the rear cover 2 and the bottom plate 2E described below are replaced by the front cover 1 and the bottom plate 1E, respectively, that explains a structure in which a fixing unit is provided at the front cover 1.

A fixing portion 30A (a fastening means) shown in FIG. 5A fastens the rear cover 2 to the frame 3 by a screw 50, in a position of the outer side of the casing adjacent to the side guide 3a. The fixing portion 30A is composed of a projected piece which projects by the length at least longer than the diameter of the screw head of the screw 50 from the side guide 3a of the inner side of the casing against the opposite side guide 3a, and has an appropriate width in the direction into the page.

At the fixing portion 30A, a female screw 30a to engage with the screw 50 is formed.

On the other hand, the rear cover 2 is provided with a through hole 32a to pass the screw 50 at a position overlapping the female screw 30a when the end surface of the rear cover 2 is pushed in to touch the web 3b.

The structure enables the rear cover 2 to be in close contact with the side guide 3a and the fixing portion 30A opposite to the inner side of the casing and to be fastened by a screw.

In this way, with respect to the rear cover 2, only the through hole 32a has to be processed, and no tapping may be made. Consequently, materials with low strength such as a wooden material can be fixed and removed repeatedly, and constitute a connecting structure excellent in durability.

FIG. 5 B shows an example in which, in addition to the fixing portion 30A, an outer fixing portion 30B is provided in a position opposite to the fixing portion 30A extended from the side guide 3a of the outer side of the casing. The outer fixing portion 30B is provided with a through hole 30b to pass the screw 50 uniaxially with the female screw 30a.

In the structure, the screw 50 can be fastened after being inserted into the through hole 30b and the through hole 32a of the rear cover 2, and the rear cover 2 can be fixed while being held between the fixing portion 30A and the outer fixing portion 30B.

The structure enables stress by the screw head of the screw 50 to be received by the outer fixing portion 30B and then dispersed to the rear cover 2, which prevents the rear cover 2 from being damaged by the screw fastening stress.

FIG. 5C shows an example in which the rear cover 2 is fixed at the bottom plate 2E, not the side. In place of the fixing portion 30A, a curved fixing portion 30C is provided that extends to a position for overlapping the bottom plate 2E along the curvature of the rear cover 2. The female screw 30a is provided in a position to overlap the bottom plate 2E, and at a portion of the bottom plate 2E corresponding to the position, the through hole 32a is provided.

In the structure, the rear cover 2 can be fixed from the backward direction (the Z axis direction in FIG. 2) that corresponds to the direction of insertion, which brings about the advantage that assembling gets easier.

As a variation of this fixing means, the frame 35 (the connecting member for covering members) shown in FIG. 5D can be employed.

The frame 35 includes a side guide 35a in place of the side guide 3a of the frame 3. The side guides 35a and 35a are provided with a fitting portion 35c, the gap between whose opposite tops is narrower than the thickness of the covering material. When thrusting the covering material into the fitting portion 35c, the fitting portion 35c is pushed outward to be open, which applies elastic force to the sides of the covering material.

In the example of FIG. 5D, a protrusion 35b is formed inside of both the top ends of the side guides 35a and 35a to form the fitting portion 35c.

On the other hand, the covers 36 and 37 are provided with a taper 36b at the top end, and fitting grooves 36a and 36a which may engage with the protrusion 35b when the top ends approach the web 3b closely.

This structure enables the covering members to be fixed easily without using a fastening material such as screws.

According to the connecting structure that connects the front cover 1 and the rear cover 2 using the frame 3 of the embodiment in accordance with the invention, since the side surfaces of the ends of the front cover 1 and the rear cover 2 are guided by the side guides 3a and 3a and the top end hits against the web 3b, the ends of the covering members can be protected from external force. As a result, scars and cracks at the top ends and side surfaces of the ends in the direction of the plate thickness can be prevented, and the durability can be improved. In particular, the connecting structure is preferable when a compressed wooden material, which tends to produce variation in strength at the end, is used as a covering member as in the embodiments.

Since the portions at which the front cover 1 and the rear cover 2 hit against the web are overlapped twofold by the side guides 3a and 3a all over the circumferential direction of the ends, an advantage is gained that good light shading effect can be obtained without using a light shading member.

Variations of the embodiments will be explained.

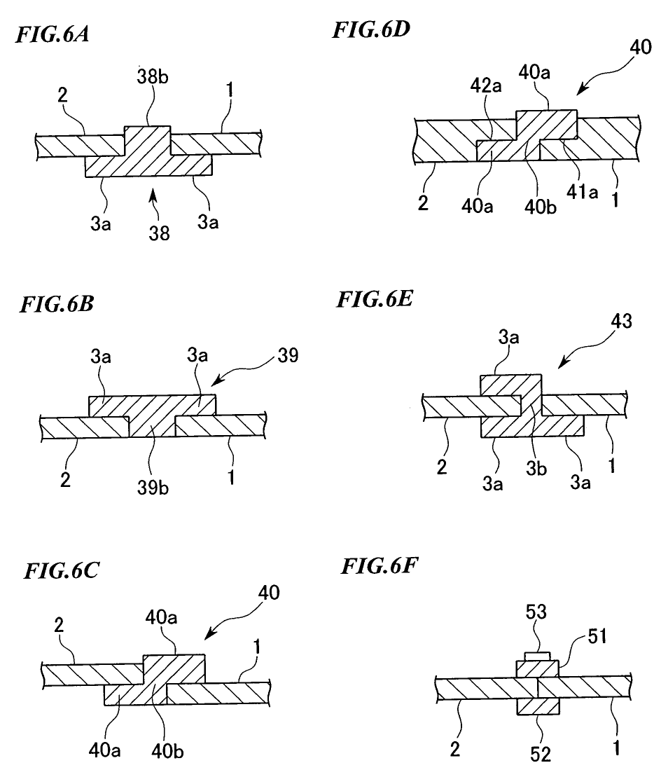

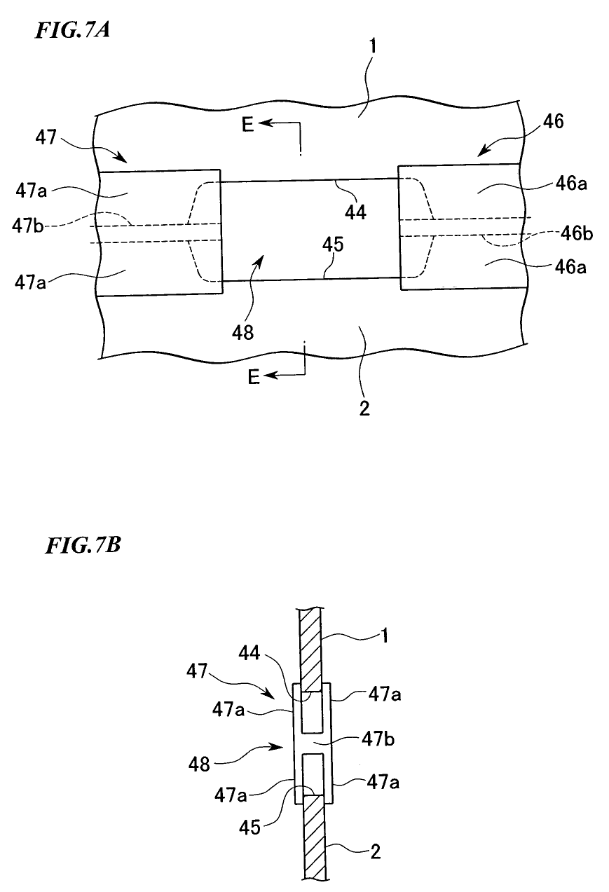

FIG. 6A is a sectional view of a first variant of an embodiment in accordance with the invention. FIG. 6B is a sectional view of a second variant of an embodiment in accordance with the invention. FIG. 6C is a sectional view of a third variant of an embodiment in accordance with the invention. FIG. 6D is a sectional view of a third variant of an embodiment in accordance with the invention. FIG. 6E is a sectional view of a fourth variant of an embodiment in accordance with the invention. FIG. 6F is a sectional view of a fifth variant of an embodiment in accordance with the invention. FIG. 7A is a side view of a sixth variant of an embodiment in accordance with the invention. FIG. 7B is a sectional view taken along E-E of FIG. 7A.

A frame 38 (a connecting member for the covering members) as a first variant of the embodiments in accordance with the invention, as shown in FIG. 6A, deletes the side guide 3a exposed to the outside of the casing with respect to the frame 3, leaving the side guides 3a and 3a in the inner side of the casing. Then, the frame 38 is provided with a projection 38b in place of the web 3b to have a T-shaped cross section. The projection 38b protrudes to a position higher than each thickness of the front cover 1 and the rear cover 2.

In the structure, since the top end of the front cover 1 and the rear cover 2 is pressed against the projection 38b from the side direction, the top end is protected and assembling becomes easier. Moreover, where the projection 38b projects outside beyond the front cover 1 and the rear cover 2, it is preferable that the side surfaces of the ends of the front cover 1 and the rear cover 2 tend to be difficult to be hit direct.

A frame 39 (a connecting member for the covering members) as a second variant of the embodiments in accordance with the invention, as shown in FIG. 6B, deletes the side guide 3a exposed to the inside of the casing with respect to the frame 3, leaving the side guides 3a and 3a in the outer side of the casing. Then, the frame 39 is provided with a projection 39b in place of the web 3b to have a T-shaped cross section. As long as a projection 39b should have a height hit by the top end of the front cover 1 and the rear cover 2, the height may be higher or lower than each thickness of the front cover 1 and the rear cover 2. When the height is lower, the space inside the casing is effectively used, which produces an advantage that the space can be saved.

In the structure, since the top end of the front cover 1 and the rear cover 2 is pressed against the projection 39b from the side direction, the top end is protected and assembling becomes easier. In addition, since the side guides 3a and 3a project outside beyond the front cover 1 and the rear cover 2, the side surfaces of the ends of the front cover 1 and the rear cover 2 are surely protected with the result that durability is improved.

A cross section of a frame 40 (a connecting member for the covering members) as a third variant of the embodiments in accordance with the invention is, as shown in FIGS. 6 C and 6D, side guides 40a and 40a (side guide portion) are projected to the direction of right and left unevenly with respect to a thrust portion 40b (end holding portion). At the rear cover 2 side, the side guide 40a slips into the inside of the rear cover 2 to have the thrust portion 40b exposed to the outside of the casing. At the front cover 1 side, the side guide 40a covers the front cover 1 from outside along the end portion of the front cover 1 to have the thrust portion 40b projected inside of the casing. The thrust portion 40b is, at least at the outer side of the casing, protruded higher than the thickness of the covering member (the rear cover 2 of FIGS. 6C and 6D) to be thrust.

The ends of the front cover 1 and the rear cover 2, as show in FIG. 6C, can be hit against the side guide 40a unevenly each having a constant thickness. Then as shown in FIG. 6D, the ends of the front cover 1 and the rear cover 2 may engage with the side guide 40a and the thrust portion 40b by being formed stepwise.

In the structure, since the ends of the front cover 1 and the rear cover 2 is pressed against the thrust portion 40b, the ends are protected and assembling becomes easier.

A frame 43 (connecting member for the covering members) as a fourth variant of the embodiments in accordance with the invention, as shown in FIG. 6E, deletes one of the side guides 3a and 3a exposed to the outside of the casing with respect to the frame 3 to produce a cross section similar to the reverse of a letter h.

According to the structure, the rear cover 2 produces the function and advantage of the embodiments, while the front cover 1 produces the function and advantage that is similar to that of the first variant.

As shown in FIG. 6F, frames 51 and 52 (connecting member for the covering members) of a fifth variant in accordance with the embodiments have annular shapes that corresponds to the side guides 3a and 3a in the frame 3. With the top end of the front cover 1 in contact with that of the rear cover 2, the neighborhood of the top ends is held in the direction of the thickness of the front and rear covers to be fixed. That is, this variant is an example of the connecting member for the covering members, which does not have an end holding portion but includes only the side guide portions.

Fixing of the front cover 1 and the rear cover 2 can employ appropriate means. For example, at an appropriate position in the circumferential direction, a through hole is provided with the frame 51; a female screw, with the frame 52; and notches on a corresponding position of the front cover 1 and the rear cover 2, respectively. Hence, a screw 53 can be used as a fixing means.

According to the structure, the frame 51 can protect the top ends of the front cover 1 and the rear cover 2 from an external force.

The frame 51 and the frame 52 may be distinct, but in order to improve assembling, it is preferable that the frames 51 and 52 be connected at some position in the circumferential direction so that a gap in the radial direction can be maintained. For example, it is preferable that the frames 51 and 52 be connected so that a cross section of H shape can be produced at a specified position.

At that time, the member to connect the frames may be used as an end holding portion.

The above explanation is made of assuming that the frame 3 is a circular frame body. Depending on situations, the frame 3 may be formed while divided in the circumferential direction of the top end of the covering member. For example, the frame 3 may be provided only at the top end having relatively lower strength among the top ends of the front cover 1 and the rear cover 2.

In the case, at positions at which the frame 3 is not placed, a suitable member shades light and blocks dust, depending on the situation.

As one such example, FIGS. 7A and 7B show a sixth variant of the embodiments.

Frames 46 and 47 (connecting member for the covering members) are obtained by dividing the frame 3 suitably in the circumferential direction, and is placed with a space in the circumferential direction. With respect to the side guide 3a, side guides 46a and 47a (side guide portion) are provided, while with respect to the web 3b, webs 46b and 47b (end holding portion). At the ends of the opposite frames 46 and 47, an aperture cutout 44, having a shape of the letter U, whose top is open to the front cover 1, is provided, and to the rear cover, an aperture cutout 45 is provided. Since the top ends of the frames 46 and 47 cover the cutouts, a square aperture 48 is formed that extends to the front cover 1 and the rear cover 2.

This type of aperture 48 is preferable, for example, as an aperture for inserting or removing a member having a square cross section such as a memory card or connector. When an aperture is provided at the sides of the front cover 1 and the rear cover 2, the aperture could not be provided near an end of the compressed wooden material having relatively lower strength due to low strength. However, as described above, the sixth variant enables an aperture to be easily provided even at the side surfaces of the end of the covers. At this time, if the ends of the frames 46 and 47 are used as parts of the aperture as in this variant, the aperture cutouts 44 and 45 have only to be used for parts of the aperture, which produces the advantage that the aperture cutouts 44 and 45 can be easily processed.

According to the variant, because an aperture cover can be attached to the ends of the frames 46 and 47 having comparatively high strength, there is also the advantage that durability of insertion and removal of the aperture cover can be improved.

The above explanation describes one example in which the frame 3 is provided with the release button attaching portion 18, the screw 19, and the supporting frame 11. In addition to that, the frame 3 may be provided with a suitable functional shape or functional member such as a hole for inserting and removing a connector, a hole for replacing a battery, a lid therefor, a hinge, and equivalents thereof. Providing the frame 3 with the functional shape and functional member simplifies the shapes of the front cover 1 and the rear cover 2, which brings about the advantage that a wooden material can be used which is inferior in formability to synthetic resin or metal.

The above explanation describes the frame 3 as a circular frame body. This shape of the frame can bear stress with respect to an external force from the outer circumference of the frame 3.

The side guide 3a and the web 3b need not necessarily be continuous all over the circumference.

For example, the cross sections at suitable positions may be transformed to those as shown in FIGS. 6A, 6B, and 6C.

Though the above explanation described the front cover 1 and the rear cover 2 as a compressed wooden material, one of the covers may be of light metal, which is a foreign material. Because each top end is pressed to touch the web 3b, respectively, it is advantageous that the ends do not damage each other by their collision. If the gap between the side guides 3a and 3a is changed, there is the advantage that the difference in plate thickness based on the difference in material can be readily covered.

The above explanation is given to an example in which a connecting member for covering members and a connecting structure using the connecting member in accordance with the invention can be applied to a digital camera as an electronic device. The invention is preferable for all the electronic devices such as a remote controller for a television set, a video recorder, an air conditioner, or a projector, a portable telephone, an IC recorder, and a PDA. In particular, the invention is most preferable for hand-held and hand-operated electronic devices to which using a wooden material as a covering member provides good hygroscopicity and good sensation.

According to a connecting member for covering members and a connecting structure using the connecting member of the invention, where the connecting member for covering members includes an end holding portion, the top end of the end portion of the covering members can be protected from an external force and moisture absorption from outside, and where the connecting member for covering members includes a side guide portions, the side surface of the end portion of the covering members in the thickness direction can be protected from an external force and moisture absorption from outside. Consequently, even in a case where the covering members include a wooden material having relatively lower strength in material quality, generation of damage and moisture absorption through the ends of the covering members can be prevented, which leads to the advantages that durability and production efficiency of the casing can be improved.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

The connecting member for covering members and the connecting structure using the connecting member in accordance with the invention can be applied to a casing of an electronic device. The connecting member and the connecting structure prevent damage and moisture absorption, and enable durability of the casing and production efficiency to be improved.

1. A connecting member for covering members for forming a casing of an electronic device, comprising:
a connecting member by which an end portion of a plurality of covering members is connected, including a covering member of which at least the end portion to be connected is made of a wooden material; and having at least one of an end holding portion and a side guide portion for connecting the covering members, the end holding portion being provided so that the end holding portion holds the top end of the end portion of each of the covering members, and, the side guide portion being provided along a side surface in a thickness direction of the end portion of each of the covering members.

2. The connecting member as recited in claim 1, wherein at least one of the end holding portion and the side guide portion is circularly continuous.

3. The connecting member as recited in claim 1, wherein the side guide portion is provided with a fastening means for removably fastening the covering members.

4. The connecting member as recited in claim 1, wherein either the end holding portion or the side guide portion projects outside of the side surface of the end portion of the covering members.

5. The connecting member as recited in claim 1, wherein the side guide portion is provided so as to hold the end portion of the covering member in the thickness direction thereof.

6. A connecting structure for forming a casing of an electronic device comprising:
a connecting member by which an end portion of a plurality of covering members is connected, including a covering member of which at least the end portion to be connected is made of a wooden material; and having at least one of an end holding portion and a side guide portion for connecting the covering members, the end holding portion being provided so that the end holding portion holds the top end of the end portion of each of the covering members, and, the side guide portion being provided along a side surface in a thickness direction of the end portion of each of the covering members; and
a plurality of covering members each having an end portion to be connected, including the covering member of which at least the end portion to be connecter being made of a wooden material.

7. The connecting structure as recited in claim 6, wherein the connecting member for the covering members is formed of a material having higher strength than a wooden material of the end portion to be connected in the covering members.
